(19) United States
(12) Patent Application Publication
(10) Pub. No.: US 2015/0199664 A1
(43) Pub. Date: Jul. 16, 2015

(54) METHODS, SYSTEMS, AND COMPUTER READABLE MEDIA FOR FACILITATING ACCESS TO TRANSPORTATION SERVICES

(71) Applicant: MasterCard International Incorporated, Purchase, NY (US)

(72) Inventors: Brien Buckman, Stamford, CT (US); Kimberly Peyton, New York, NY (US); Mark Lulic, Mohegan Lake, NY (US)

(73) Assignee: MasterCard International Incorporated, Purchase, NY (US)

(21) Appl. No.: 14/156,038

(22) Filed: Jan. 15, 2014

(51) Int. Cl. G06Q 20/14; G06Q 20/42; G06Q 50/30

(52) U.S. Cl. CPC G06Q 20/145; G06Q 50/30; G06Q 20/42

(57) ABSTRACT

Methods, systems, and computer readable media for facilitating access to transportation services are provided. One system includes an application configured to execute on a computing device. The application is configured to determine information about a route being traveled or to be traveled by a user. The application is configured to identify a transportation service associated with the route and an authority associated with the transportation service. The application is configured to obtain authorization from the authority for access to the transportation service. A server is configured to communicate with the application and with the authority to facilitate the obtaining of the authorization to access the transportation service.

### TECHNICAL FIELD

The subject matter described herein relates to facilitating access to transportation services. More particularly, the subject matter described herein relates to methods, systems, and computer readable media for facilitating access to transportation services.

### BACKGROUND

Transportation services, such as toll road services and carriage services, including but not limited to rail, bus, and airline transportation services, sometimes require the user to have a special purpose transponder in order to access the services. For example, on many toll roads, users affix radio frequency transponders to their vehicles that communicate with stationary transponders located at toll gates on the toll road to allow the users to access the toll road and to collect payment from the users. If a user's vehicle lacks a transponder, the user may be required to pay cash in order to access the toll road, which may be inconvenient and lead to longer delays at toll gates. Some toll road systems, such as the SunPass system on the Florida Turnpike, no longer accept cash payments and require vehicle transponders for access to the toll road. Accessing the toll road without a transponder will result in the user receiving a ticket and a corresponding fine. Rental car companies take advantage of this fact and provide transponders as an option to be purchased as part of the car rental agreement. However, the rental car companies typically charge a daily fee for use of a transponder, which increases the cost to the consumer for accessing the toll road.

In some toll road systems, toll roads can be accessed with or without a transponder. In such systems, if a vehicle without the transponder passes a toll gate, a camera mounted to the toll gate photographs the vehicle's license plate, and a bill for the toll is mailed to the address of the vehicle's registered owner. Such systems are inefficient, as the identification of the registered owner's address, the mailing of bills, and the collection of tolls by mail increase the cost to the transportation service provider for collecting tolls. Collection of the tolls is also delayed by the mailing of bills, user time to pay the bills, and the mailing of payments.

In toll road systems where transponders are optional, users with transponders are typically charged a lower toll than users without transponders. Visiting users to a locality where transponders are optional are unlikely to obtain a transponder due to the administrative steps required to obtain a transponder. For example, users may be required to visit a division of motor vehicles in a locality to obtain a transponder. Thus, administrative burdens in obtaining transponders can lead to users not obtaining transponders and paying higher tolls or avoiding toll roads or other transportation services.

Still another problem associated with conventional transportation service payment systems is that the transponders used to access such systems provide little or no additional functionality other than tracking whether a user passes a toll gate so that the user's account can be debited. Transportation service providers and/or third parties may desire to provide additional services to users, including loyalty rewards and location-based advertisements. Because conventional transponders lack the capability to provide these services, such services have not been provided by transportation service providers.

In addition, transponders offer no ability for the user to plan a route in advance of traveling the route. Such a service might be useful if the user desires to pre-plan a route based on costs or convenience and pay for access to the route in advance to expedite travel. Conventional transponders lack the capability for route pre-planning and pre-payment.

In light of these and other shortcomings associated with accessory transportation services, there exists a need for methods, systems, and computer readable media for facilitating access to transportation services.

### SUMMARY

Methods, systems, and computer readable media for facilitating access to transportation services are provided. One system includes an application configured to execute on a computing device. The application is configured to determine information about a route being traveled or to be traveled by a user. The application is configured to identify a transportation service associated with the route and an authority associated with the transportation service. The application is configured to obtain authorization from the authority for access to the transportation service. A server is configured to communicate with the application and with the authority to facilitate the obtaining of the authorization to access the transportation service.

The subject matter described herein may be implemented in hardware, software, firmware, or any combination thereof. As such, the terms “function” “node” or “module” as used herein refer to hardware, which may also include software and/or firmware components, for implementing the feature being described. In one exemplary implementation, the subject matter described herein may be implemented using a computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

The subject matter described herein will now be explained with reference to the accompanying drawings of which:

FIG. 1 is a block diagram illustrating an exemplary system for facilitating access to transportation services according to an embodiment of the subject matter described herein;

FIG. 2 is a block diagram illustrating an exemplary application for facilitating access to transportation services according to an embodiment of the subject matter described here;

FIG. 3 is a block diagram illustrating additional details of the system for facilitating access to transportation services according to an embodiment of the subject matter described herein;

FIG. 4 is a flow chart illustrating an exemplary enrollment process for enrolling or subscribing to use a system for facilitating access to transportation services according to an embodiment of the subject matter described herein;

FIGS. 5A and 5B are flow charts illustrating exemplary steps for planning a route using the system for facilitating access to transportation services according to an embodiment of the subject matter described herein;

FIGS. 6A and 6B are flow charts illustrating exemplary steps performed by a system for facilitating access to transportation services where a route is not selected in advance according to an embodiment of the subject matter described herein; and

FIG. 7 is a flow chart illustrating exemplary steps performed by a system for facilitating access to transportation services where an application on a computing device communicates with or emulates a transponder to facilitate access to transportation services according to an embodiment of the subject matter described herein.

### DETAILED DESCRIPTION

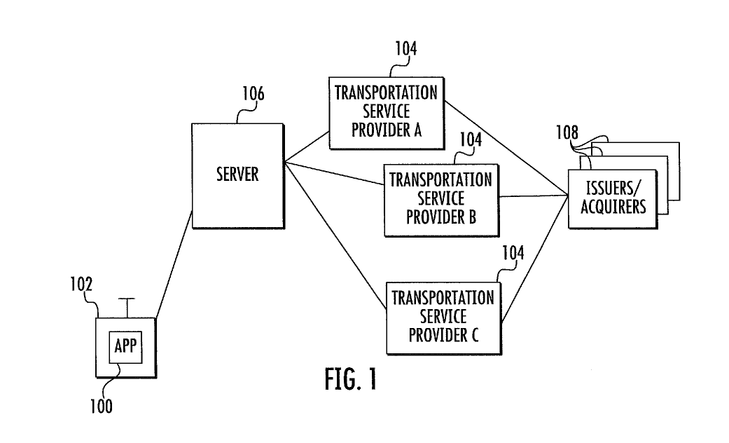

Methods, systems, and computer readable media for facilitating access to transportation services are provided. FIG. 1 is a block diagram illustrating a system for facilitating access to transportation services according to an embodiment of the subject matter described herein. Referring to FIG. 1, the system includes an application 100 configured to execute on a computing device 102. Application 100 may facilitate route planning and/or continuous location determination so that the user can pay for access to transportation services. In one example, the user may input a desired route, and application 100 may identify transportation service providers needed for the user to access the route. If application 100 performs continuous location identification, application 100 may use a global positioning system (GPS) or other locating capabilities of computing device 102 to continually determine the location of the user and to identify transportation services impacted by the user's route. Such a determination may be made in real time while the user is traveling.

Computing device 102 may be any suitable device for executing application 100 and for traveling with a user while accessing a transportation service. For example, computing device 102 may be a mobile phone, such as a smart phone, a tablet computer, a laptop computer, a vehicle integrated computer, a wrist watch computer, a head mounted or eyeglasses integrated computer, or any combination thereof. The term “vehicle integrated computing device” is intended to include an in-dash system in a personal automobile as well as a corresponding system that may be present in a bus or other mass transit vehicle. Computing device 102 may include a processor, implemented in hardware, for executing application 100 and a memory for storing data needed or generated by application 100.

Another function of application 100 may be obtaining authorization for access to transportation services. For example, application 100 may contact transportation service providers 104, either directly or via a server 106, associated with an actual or planned route of the user to obtain authorization for the user to access the services. In one example, the transportation service providers may be toll road authorities that charge the user for access to toll roads. In another example, transportation service providers 104 may be carriage service providers, such as rail, bus, ferry, or air travel providers. Transportation service providers 104 may interface with issuers/acquirers 106 to determine whether or not to allow the user of device 102 to access a given service. Issuers/acquirers 108 may be the standard issuers and acquirers used by transportation service providers 104 to authorize toll transactions using existing transponder systems. As a result, no changes or very few changes to the transportation service provider's existing payment and authorization systems are required in order to implement the subject matter described herein. Thus, in order to obtain authorization to access transportation services, application 100, either directly or through server 106 may identify the needed service (e.g., access to a toll road or carriage service) and contact the relevant authority to obtain authorization for the access, where the authority may be the transportation service provider, the issuer/acquirer, or other entity that authorizes access to the identified service.

Server 106 may include a combination of hardware and software that communicates with application 100 and with the relevant authorities for facilitating access to transportation services. As such, server 106 may include a processor and associated memory for performing these functions. Server 106 may be under the administrative domain of a transportation service provider, an issuer, an acquirer, an authority or an entity separate from transportation service providers, issuers, acquirers or authorities. In one embodiment of the subject matter described herein, server 106 may be managed by an entity separate from transportation service providers, their associated issuers/acquirers or authorities and may interface with the appropriate entity in a manner that does not require a change to the existing payment infrastructure for accessing transportation services. For example, server 106 may use the existing payment and authorization mechanisms for accessing transportation services when the access device is a conventional vehicle transponder or other existing access device.

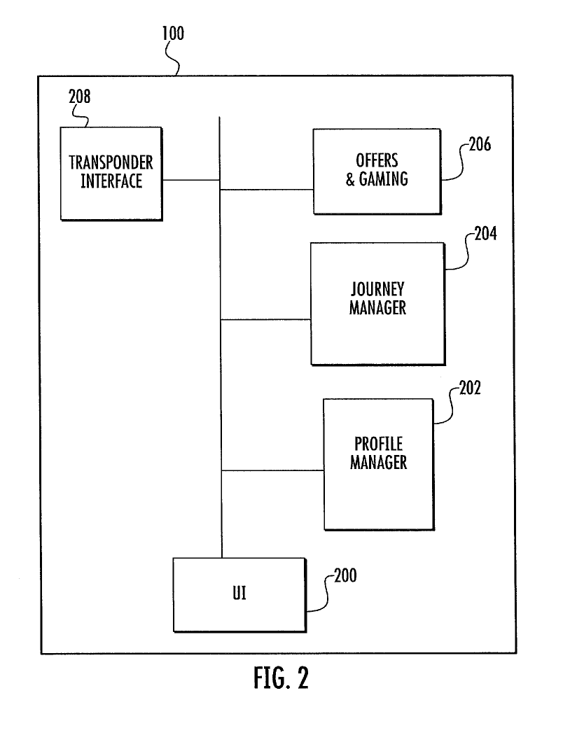

FIG. 2 is a block diagram illustrating exemplary components of application 100 for facilitating access to transportation services according to an embodiment of the subject matter described herein. Referring to FIG. 2, application 100 includes a user interface 200 for allowing the user to access various services provided by application 100. In the illustrated example, the services enabled by application 100 include profile management provided by profile manager 202, journey management provided by journey manager 204, offers and gaming provided by offers and gaming module 206, and transponder communication provided by transponder interface 208. Profile manager 202 may obtain and store user profile information, payment information, vehicle information, and loyalty and offer preference information received via UI 200. User profile information may include the user's name and contact information. Payment information may include credit or debit card information or other payment type information, e.g., Bitcoin, PayPal, etc. that the user uses to pay for transportation services. Vehicle information may include the vehicle year, make and model, vehicle identification number, license plate number, or other information usable to identify the vehicle used to access transportation services. Loyalty and offer preference information may include loyalty accounts maintained by the user for transportation services and the user's preferences with regard to receiving offers from transportation service providers. Profile manager 202 may store at least some of this information locally on computing device 102 and provide some of the information to server 106. Journey manager 204 may perform route planning, fare calculation, authorization storage, and journey summary storage. Journey manager 204 may interface with a geolocation service provider, either directly or via server 106, for route planning. Fare calculation may involve contacting transportation service providers 104 to determine the total fare for a planned route. Authorization storage may include storing authorization information received from transportation service providers 104. Journey summary storage may include storing a record summarizing a route traveled by the user.

Offers and gaming module 206 may maintain a history of offers previously made to the user, maintain a history of offers redeemed by the user, maintain points account balances for points used by the user, and may store loyalty and offer preferences of the user. In one example, a transportation service provider may offer rewards based on the number of trips completed, the number of toll gates accessed, the number of miles traveled, or other metric of travel along a planned route. Such rewards may be stored by offers and gaming module 206 and may be used to pay for future transportation services or other services/products.

Transponder interface 208 may communicate with toll point transponders to allow the user to access and be charged for accessing transportation services. In one example, transponder interface 208 may emulate a conventional toll transponder and communicate with toll point transponders using the same protocols used by dedicated transponder devices. In another example, transponder interface 208 may operate in conjunction with a connected third party device, such as a vehicle toll transponder, to facilitate access to transportation services.

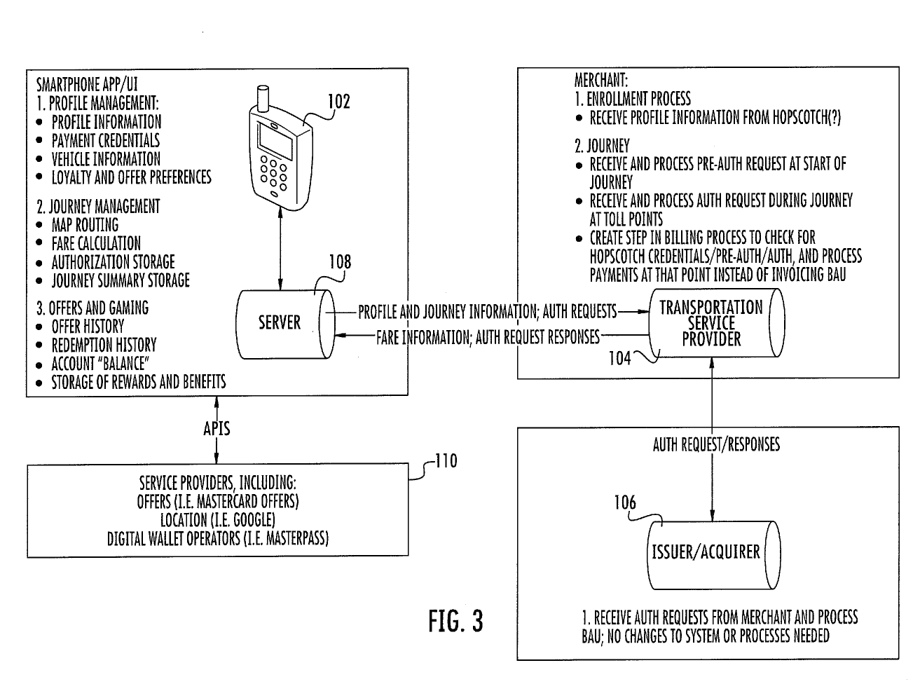

FIG. 3 is a block diagram illustrating exemplary details of the system for facilitating access to transportation services illustrated in FIG. 1. In FIG. 3, the various functions of each component are illustrated. In addition, only a single transportation service provider 104 is illustrated. It is understood that server 106 may communicate with multiple transportation service providers to obtain authorization before or during a route. FIG. 3 also illustrates additional service providers 110 that may provide geolocation services, digital wallet services, cloud payment services, or loyalty offers to the user via application 100 executing on computing device 102.

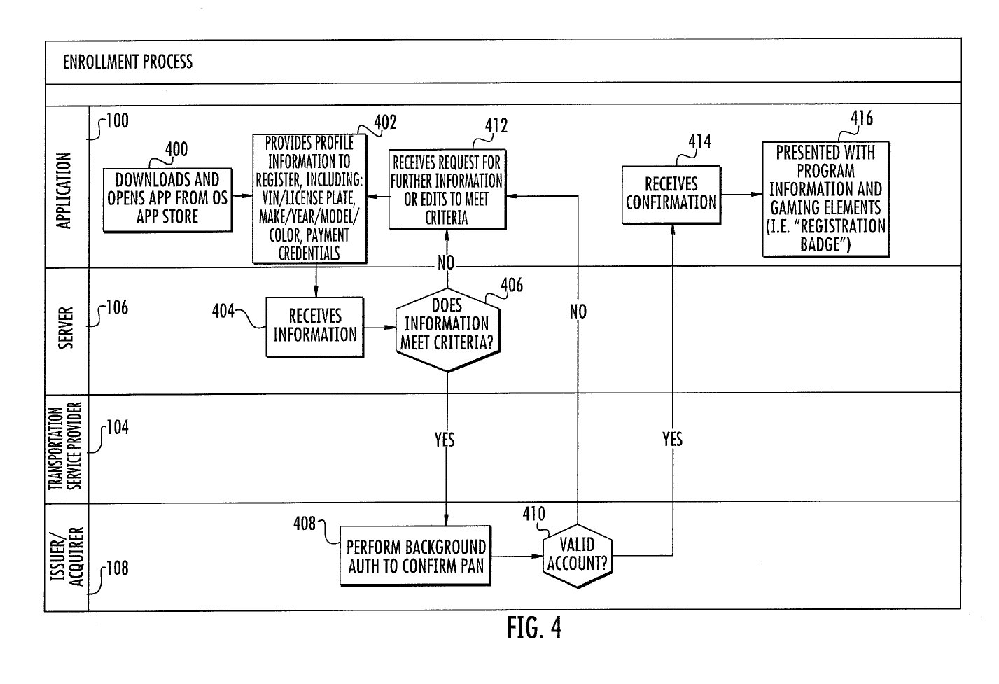

Prior to accessing transportation services, the user may be required to enroll with server 106. FIG. 4 is a flow chart illustrating an exemplary enrollment process. Referring to FIG. 4, in step 400, the user downloads application 100, for example, from an app store specific to the operating system on computing device 102. In step 402, the user provides profile information including vehicle information and payment credentials. If the service being accessed is not a toll road service, vehicle information can be omitted. In step 404, server 106 receives the information and in step 406 determines whether the information satisfies predetermined criteria. The predetermined criteria may include verifying that all required input fields are completed and that the input data is validly formatted. If the predetermined criteria of server 106 are satisfied, control proceeds to step 408 where the user's payment information is validated by issuer/acquirer 108. In the illustrated example, the user's Personal Account Number (PAN) is checked. If the PAN is not valid, control proceeds to step 412 where the information is re-requested from the user. If the user's PAN represents a valid account, control proceeds to step 414 where the user is provided with confirmation that the information entered has been validated. In step 416, application 100 presents the user with a registration badge confirming registration and may also present the user with gaming elements.

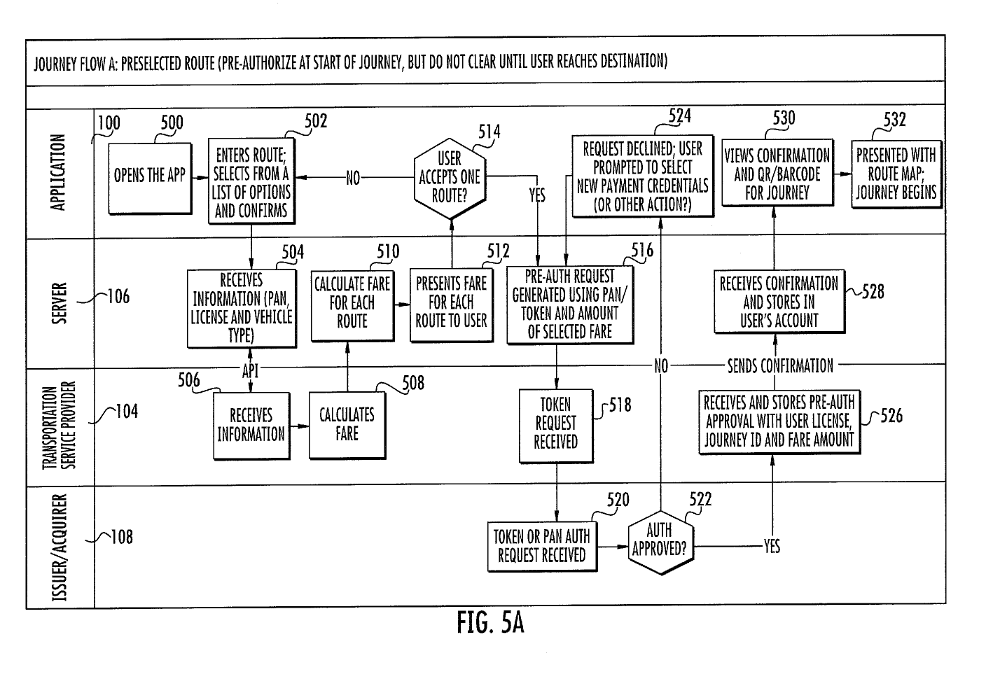

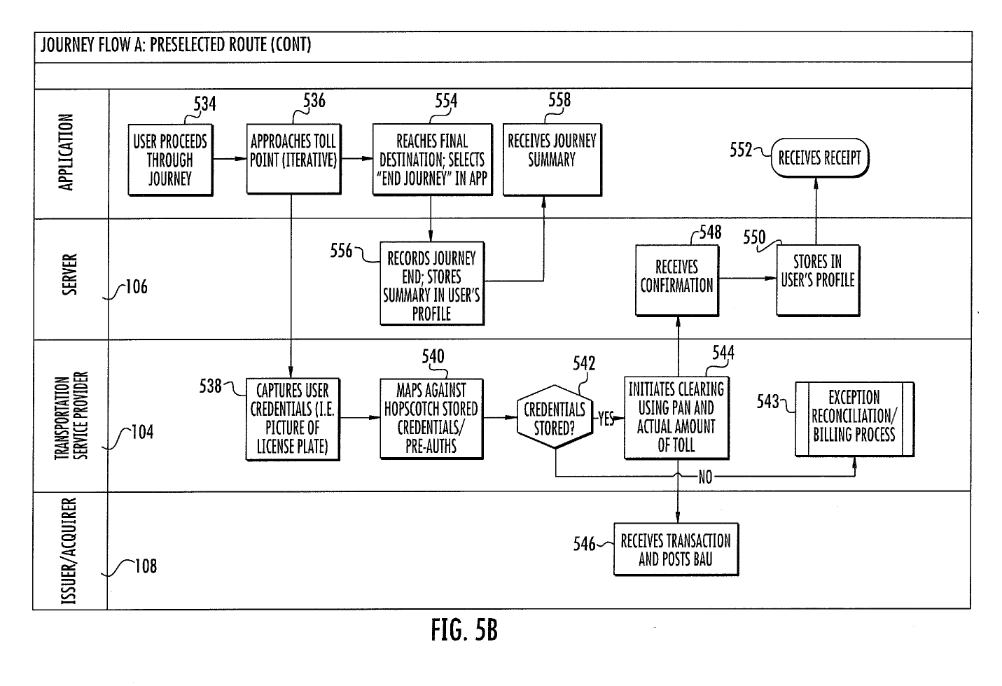

As stated above, functions of application 100 and server 106 include allowing the user to pre-plan a route, identifying and obtaining advance authorization from transportation service providers 104, and prepaying for the route. FIGS. 5A and 5B illustrate exemplary steps performed by the system illustrated in FIGS. 1 and 3 for journey management for a pre-planned route. Referring to FIG. 5A, in step 500, the user opens application 100. In step 502, the user enters a route desired to be traveled, selects from a list of options, and confirms the user's selection. The options may include one or more routes between a source and a destination selected by the user. Application 100 may interact with a geolocation service to obtain routes between a source and a destination input by the user.

In step 504, server 106 receives information from application 100, including payment information, vehicle license information, and vehicle type. In step 506, application 100 identifies transportation service providers whose toll gates or other services will be required for the route, provides the user input information to the identified transportation service providers 104, and requests charge information for the route. In step 508, each transportation service provider 104 calculates the required fares and provides this information to server 106. In step 510, server 106 calculates the total fees for each route and, in step 512, presents the total fare to the user via application 100. In step 514, application 100 determines whether the user accepts one of the routes or returns to step 502 for the user to enter another route.

If the user decides to accept one of the routes, application 100 communicates an indication of the user's acceptance to server 106, and, in step 516, server 106 generates and sends to each transportation service provider 104 preauthorization requests using the user's PAN or a token that maps to the PAN and the amount of the selected fare. In step 518, each transportation service provider 104 receives the preauthorization request and, in step 520, provides the preauthorization request to its respective issuer/acquirer 108. In step 522, each issuer/acquirer 108 determines whether to authorize the request. If the request is declined, control proceeds to step 524, where the denial is communicated to application 100, and the user is prompted to enter new payment information or take other action.

In step 522, if the request for preauthorization is approved, control proceeds to step 526 where each transportation service provider 104 receives and stores the preauthorization approval with the user license, journey ID, and fare amount. In step 528, server 106 receives confirmation of the preauthorization requests from the transportation service providers 104 and stores the preauthorizations in the user's account record on either the application, the server, or both. In step 530, server 106 communicates the confirmation to application 100, and application 100 presents the confirmation along with a QR or bar code for the journey as necessary. In step 532, application 100 presents the user with a map for the journey.

FIG. 5B illustrates exemplary steps performed by the system illustrated in FIGS. 1 and 3 when a user travels a pre-planned route. Referring to FIG. 5B, in step 534, the user proceeds through the journey with computing device 102 with application 100 in the activated state. In step 536, the user approaches a toll point. In step 538, the transportation service provider 104 associated with the toll point captures user credentials, such as a picture of the user's license plate. In step 540, the transportation service provider 104 maps the captured credentials against those stored during preauthorization. In step 542, the transportation service provider 104 determines whether the captured credentials match any of the stored credentials. If a match does not exist, control proceeds to step 543 where an exception reconciliation or billing process is initiated. If a match exists, control proceeds to step 544 where transportation service provider 104 initiates clearing of the transaction using the user's PAN extracted from the matching record and the amount of the toll. In step 546, transportation service provider 104 provides the toll transaction clearing information to issuer/acquirer 108, which posts the charge to the user's account. If the toll amount is greater than the amount requested during preauthorization, issuer/acquirer 108 may notify transportation service provider 104 which notifies server 106, and server 106 may notify the user of the shortfall so that the user can request authorization for additional funds. In step 548, transportation service provider 104 provides confirmation of the successful payment for the toll to server 106. In step 550, server 106 stores the confirmation of the payment for the toll in the user's profile. In step 552, server 106 transmits a receipt for payment of the toll to application 100 and application 100 stores the receipt in the user's transaction history for the route and presents the receipt to the user. Steps 536-552 may be performed iteratively each time the user approaches a toll point.

In step 554, application 100 determines that the user has reached the final destination defined in the pre-planned route. Application 100 may present the user with an option to end or continue the journey. In this example, is assumed that the user selects to end the journey, and the user's selection is communicated to server 106. In step 556, server 106 stores a summary of the completed journey in the user's profile and provides the summary to application 100. In step 558, application 100 receives the summary of the completed journey and presents the summary to the user. The summary may indicate the total cost of the journey, the number of miles traveled, the start and endpoints, and the number of loyalty points earned.

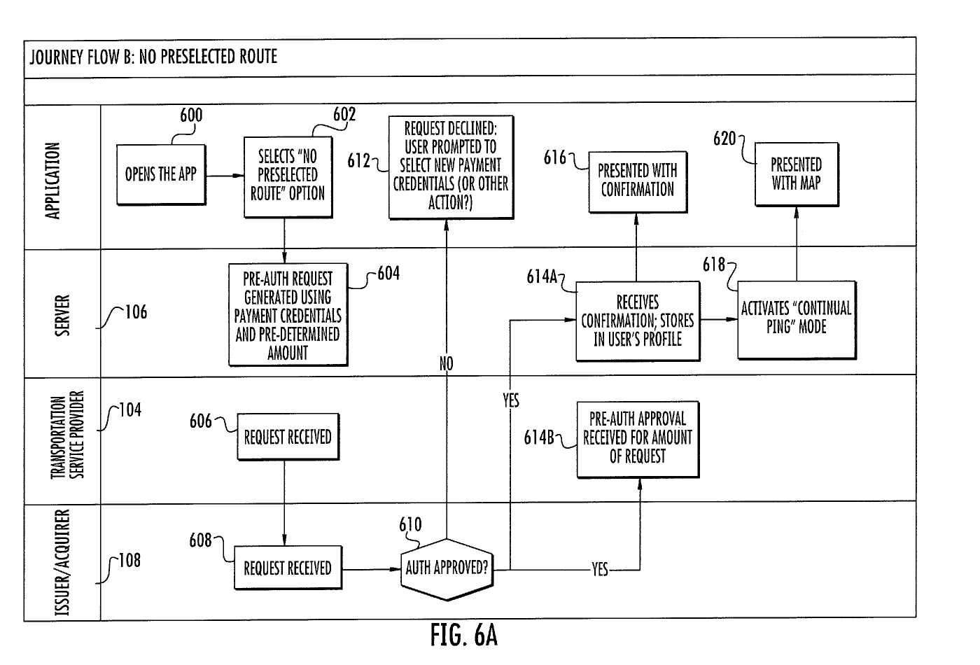

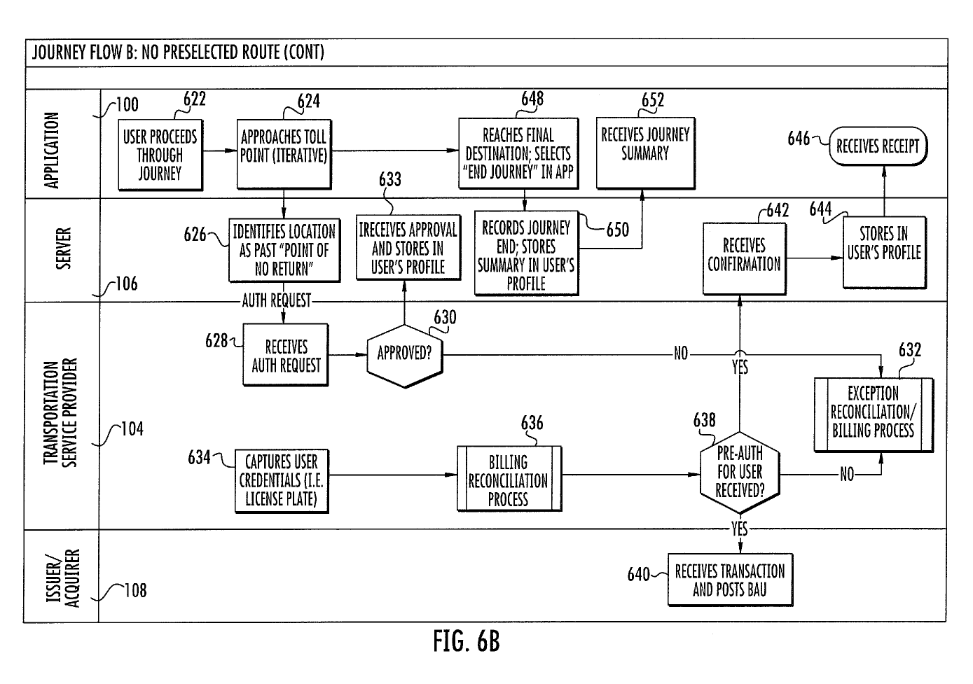

As set forth above, according to another aspect of the subject matter described herein, application 100 and server 106 may function in a mode where routes are not planned in advance. FIGS. 6A and 6B are a flow chart illustrating exemplary steps performed by the system illustrated in FIGS. 1 and 3 for facilitating access to transportation services when a route is not planned in advance. Referring to FIG. 6A, in step 600, the user opens application 100. In step 602, the user selects the “no preselected route option” presented to the user by application 100. In response to receiving the user's selection of the no pre-selected route option, application 1008, in step 604, may request authorization from server 106 for a predetermined amount of credit, such as $50 or $100 to be used in paying for transportation services accessed by the user during the non-preplanned route. In steps 606 and 608, the preauthorization request is communicated by server 106 to one or more transportation service providers 104 and by transportation service providers 104 to their respective issuer/acquirers 108. In step 610, each issuer/acquirer 108 determines whether the request for preauthorization is approved. If the request for preauthorization is not approved, the denial of the request is communicated to application 100, and, in step 612, application 100 prompts the user to enter new payment credentials.

If the request for preauthorization is approved, control proceeds to step 614 where the approval is communicated to server 106, and server 106 stores an indication of the approval and the approved amount in the user's profile. In step 614B, preauthorization approval is communicated to transportation service provider 104. In step 616, application 100 communicates confirmation of the approval to the user. In step 618, server 106 activates application 100 to operate in continuous ping mode where application 100 is configured to receive and respond to location update requests from server 106. For example, server 106 may periodically send location update request messages to application 100. Application 100 may respond to the requests with the current location of computing device 102 using GPS or other location data available to computing device 102. In step 620, application 100 presents the user with a map. The map may begin at the user's current location and may also display roads and toll points near the user's current location.

Referring to FIG. 6B, in step 622, the user proceeds through the journey. In step 624, the user approaches a toll point. In step 626, server 106 identifies the current location of the user as being past a point of no return and thus justifying a toll charge. In step 628, server 106 transmits an authorization request to the transportation service provider 104 associated with the current toll point. In step 630, transportation service provider 104 determines whether to approve the request. In the request is not approved, control proceed to step 632 where an exception reconciliation/billing process is invoked. The exception reconciliation/billing process may generate a paper bill that is mailed to the address of the vehicle owner.

If the request is approved, control proceeds to step 633, where transportation service provider 104 communicates an indication of the approval to application 100 and stores the indication in the user's profile. Once the user passes the toll point, control proceeds to step 634 where transportation service provider 104 captures user credentials, such as the vehicle's license plate. In step 636, transportation service provider 104 initiates a billing reconciliation process to charge the user for passing the toll point. In step 638, the transportation service provider 104 determines whether a preauthorization for funds to pay for the service has been received from the user. If preauthorization has been received by transportation service provider 104, control proceeds to step 640 where the issuer/acquirer 108 processes the toll transaction using the preauthorized funds. Transportation service provider 104 communicates confirmation of completion of the transaction to server 106, which receives the confirmation in step 642. In step 644, server 106 stores an indication of confirmation of completion of the toll transaction in the user's profile. In step 646, server 106 communicates confirmation of the transaction to application 100.

In step 548, application 100 determines that the user has reached the final destination. Application 100 may present the user with an option to end or continue the journey. In this example, it is assumed that the user selects to end the journey, and the user's selection is communicated to server 106. In step 550, server 106 stores a summary of the completed journey in the user's profile and provides the summary to application 100. In step 552, application 100 receives the summary of the completed journey and presents the summary to the user. The summary may indicate the total cost of the journey, the number of miles traveled, the start and endpoints, and the number of loyalty points earned.

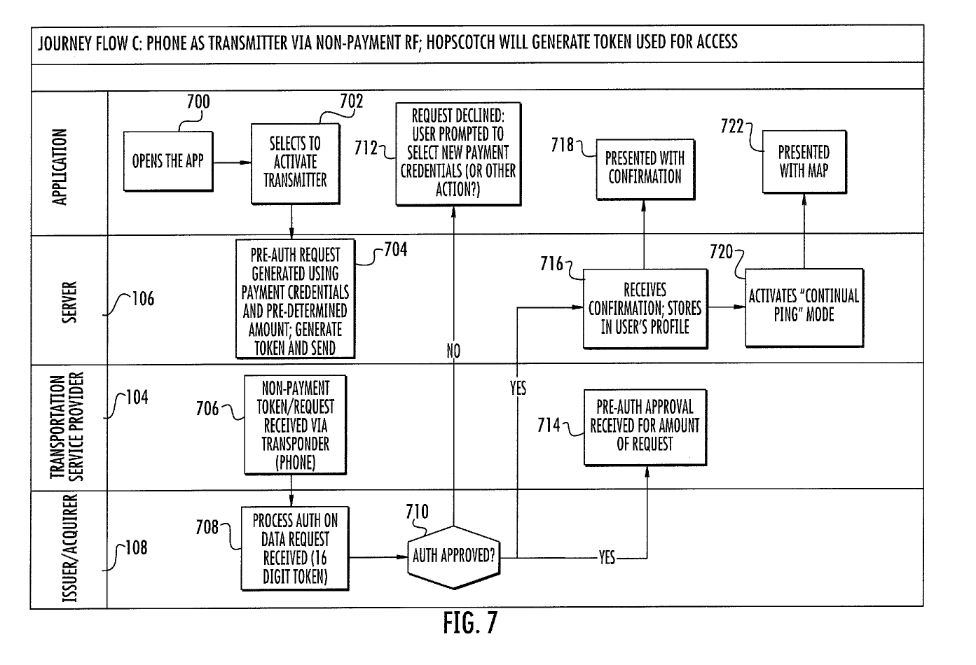

In the examples illustrated in FIGS. 5 and 6, charges for accessing transportation services are determined by a route plan and/or continually pinging application 100 to determine when it passes a toll point or an associated “point of no return.” In an alternate implementation, application 100 may be configured to emulate or communicate with a vehicle transponder to facilitate access to transportation services. FIG. 7 illustrates exemplary steps that may be performed by the systems illustrated in FIGS. 1 and 3 where application 100 configures computing device 102 to operate in transponder emulation or communication mode according to an embodiment of the subject matter described herein. Referring to FIG. 7, in step 700, the user opens application 100. In step 702, the user selects, via application 100, to activate the transmitter, which puts computing device 102 in transponder emulation mode or transponder communication mode. In transponder emulation mode, application 100 configures computing device 100 to emulate a conventional vehicle transponder by communicating with toll point transponders in the same protocols used by dedicated vehicle transponders. In transponder communication mode, application 100 configures computing device 102 to connect with a third party device, such as a vehicle transponder, where the connected devices facilitate access to transportation services and provide additional services, such as loyalty rewards offers, to the user.

In step 704, server 106 generates a preauthorization request using payment credentials entered by the user. The preauthorization request may be for a predetermined or user-configurable amount to spend on transportation services. Server 106 may also generate a token usable by application 100 to access transportation service. The token may be a code that is usable to reconcile or authorize payment for transportation services without communicating the user's account information to the transportation service provider. In step 706, server 106 communicates the preauthorization request to transportation service provider 104, and, in step 708, transportation service provider 104 communicates the preauthorization request to the associated issuer/acquirer 108. In step 710, the issuer/acquirer 108 either approves or denies the request based on the credentials entered by the user. If issuer/acquirer 108 denies the request, control proceeds to step 712, where an indication of the denial is communicated to application 100 and to the user. Application 100 may prompt the user to enter new payment credentials or take other action.

In step 710, if issuer/acquirer 108 approves the preauthorization request, confirmation of the approval is communicated to transportation service provider 104 in step 714 and to server 106 in step 716. Server 106 communicates the preauthorization to application 100, and, in step 718, application 100 presents confirmation of the preauthorization to the user. In step 720, server 106 activates continuous ping mode where application 100 is continually pinged for its current location. In step 722, application 100 presents the user with a map, which the user uses to travel a desired route. Traveling a route using application 100 executing in transponder emulation or communication mode may be performed similarly to the steps illustrated in FIG. 6B.

As stated above, the subject matter described herein is not limited to facilitating access to toll roads. In an alternate implementation, the same preauthorization, route planning, and journey tracking steps may be applied to other transportation services, such as bus, rail, ferry, or air transportation services. In one example, application 100 and computing device 102 may function to facilitate access and payment for transport in a subway system. In such an example, application 100 along with server 106 may track the time that a user enters a particular subway station and boards a train and the time and station from which the user departs the subway system. Preauthorization from the transportation authority may be obtained in the same manner described above. Either route planning or continuous location tracking as the user travels through the subway system may be performed as described above.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A system for facilitating access to transportation services, the system comprising:
an application configured to execute on a computing device, the application being configured to receive or determine information regarding a route being traveled or to be traveled by a user, to identify a transportation service associated with the route and an authority for the identified transportation service, to obtain authorization from the authority for the user to access the transportation service; and
at least one server configured to communicate with the application and with the authority to facilitate the obtaining of the authorization to access the transportation service.

2. The system of claim 1 wherein the application is configured to receive and manage user credentials and payment information.

3. The system of claim 2 wherein the payment information includes credit or debit card or other payment type information used by the user to pay for the transportation service.

4. The system of claim 1 wherein the application is configured to receive information from the user regarding a planned route before the user travels the route, to interface with a geolocation service to identify the authority associated with the planned route, and to obtain the authorization and confirmation of service fulfillment from the authority.

5. The system of claim 1 wherein the application is configured to continually determine the location of the user as the user travels the route and to obtain authorization from and facilitate payment to the authority for access to the route.

6. The system of claim 1 wherein the application is configured to perform transponder emulation where the application emulates a toll transponder or transponder communication mode where the application connects with a toll transponder to facilitate access to transportation services.

7. The system of claim 1 wherein the application is configured to execute on a mobile phone, a tablet computer, other portable computing device, or on a vehicle-integrated computing device.

8. The system of claim 1 wherein the transportation service includes access to a toll road.

9. The system of claim 1 wherein the transportation service includes carriage service.

10. The system of claim 1 wherein the application and the at least one server are configured to present an offer associated with the transportation service to the user.

11. The system of claim 1 wherein the application is configured to obtain confirmation of completion of access to the transportation service.

12. A method for facilitating access to transportation services, the method comprising:
using an application configured to execute on a computing device:
receiving or determining information about a route being traveled or to be traveled by a user;
identifying a transportation service associated with the route and an authority for authorizing access to the transportation service; and
communicating with at least one server to facilitate obtaining of authorization to access the transportation service.

13. The method of claim 12 comprising receiving and managing, by the application, user credentials and payment information.

14. The method of claim 13 wherein the payment information includes credit or debit card or other payment type information used by the user to pay for the transportation service.

15. The method of claim 12 wherein receiving or determining information about the route includes receiving information from the user regarding a planned route before the user travels the route, interfacing with a geolocation service to identify the transportation service and the authority associated with the planned route, and obtaining the authorization and confirmation of service fulfillment from the identified authority.

16. The method of claim 12 wherein receiving or determining information about the route includes continually determining the location of the user as the user travels the route, and obtaining authorization from and facilitating payment to the authority for access to the route.

17. The method of claim 12 comprising emulating or communicating with a toll transponder using the application to facilitate access to transportation services.

18. The method of claim 12 wherein the application is configured to execute on a mobile phone, a tablet computer, other portable computing device, or on a vehicle-integrated computing device.

19. The method of claim 12 wherein the transportation service includes access to a toll road.

20. The method of claim 12 wherein the transportation service includes carriage service.

21. The method of claim 12 comprising presenting to the user and via the application an offer associated with the transportation service.

22. The method of claim 12 comprising, using the application, obtaining confirmation of completion of access to the transportation service.

23. A non-transitory computer readable medium having stored thereon executable instructions that when executed by the processor of a computer control the computer conform steps comprising:
using an application configured to execute on a computing device:
receiving or determining information about a route being traveled or to be traveled by a user;
identifying a transportation service associated with the route and an authority associated with the transportation service; and
communicating with at least one server to facilitate obtaining of authorization to access the transportation service.
